(19) United States
(12) Patent Application Publication
(10) Pub. No.: US 2019/0188714 A1
(43) Pub. Date: Jun. 20, 2019

(54) METHOD FOR PERMITTING A TRANSACTION INDICATING AN AMOUNT THAT IS LESS THAN A THRESHOLD AMOUNT

(71) Applicant: MASTERCARD INTERNATIONAL INCORPORATED, PURCHASE, NY (US)

(72) Inventor: Sonali Jain, Maharashtra (IN)

(21) Appl. No.: 16/191,010

(22) Filed: Nov. 14, 2018

(30) Foreign Application Priority Data
Dec. 19, 2017 (SG) 10201710563V

(51) Int. Cl. G06Q 20/40; G06Q 20/20

(52) U.S. Cl. CPC G06Q 20/405; G06Q 20/202

(57) ABSTRACT

According to a first aspect, there is provided a POS terminal for permitting a transaction indicating an amount that is less than a threshold amount, the POS terminal comprising: at least one processor; and at least one memory including computer program code; the at least one memory and the computer program code configured to, with the at least one processor, cause the POS terminal at least to: receive transaction data relating to the transaction, the transaction data indicating the amount; determine if the amount indicated in the transaction data is less than the threshold amount, the threshold amount referring to an amount that the POS terminal is authorised to permit; and permit the transaction to proceed in response to the determination if the amount is less than the threshold amount.

### CROSS REFERENCE TO RELATED APPLICATION

This application claims priority to Singapore Application No. 10201710563V, filed Dec. 19, 2017, entitled “Method for Permitting a Transaction Indicating an Amount That Is Less Than a Threshold Amount”, the entirety of which is incorporated herein by reference.

### FIELD OF INVENTION

The present invention relates broadly, but not exclusively, to methods for enabling a transaction indicating an amount that is less than a threshold amount, and corresponding POS terminals, payment network servers and computer readable media thereof.

### BACKGROUND

Conventional systems and/or devices (for example, a POS terminal) specifically those belonging to merchants, typically lack capabilities that can permit a transaction to proceed. POS terminals usually require an internet connection with a payment network server in order to process payment. Transactions utilizing such POS terminals tend to take some time for online communication between the POS terminal and the corresponding payment network server to process the transaction. More often than not, merchants may lose sales during peak business hours as potential consumers are put off by the time needed to process the transaction and resulting long queues to the merchants' POS terminals. Such transactions are also vulnerable to weak, unstable internet connections and, in the worst case, internet outages.

Payment network servers (such as one associated with Mastercard®) that process transaction data forwarded from POS terminals typically have to handle large amounts of such data round the clock. This is because a transaction that occurs at a POS terminal typically results in a forwarding of data relating to the transaction to a corresponding payment network server, and such transactions number in the millions every hour worldwide. Network bandwidth used for forwarding such data, as well as processing power needed to process the data, looks set to increase even further in view of the current movement in many countries such as China, India, U.S. and many others to embrace a cashless society.

Further, conventional systems are often limited to specific individual processes or functions, demanding users (for example, merchants) to invest in multiple systems or services in order to perform different activities. For example, a merchant, especially one who deals with cash transactions on a daily basis, may encounter shortcomings when dealing with change. The merchant will incur administrative expenses associated with small-value denominations in the form of notes and coins for cash transactions with consumers. The merchant may have to invest in an accounting solution to capture cash-based transaction data.

A need therefore exists to provide methods and/or systems to address at least one of the above problems.

### SUMMARY

According to a first aspect, there is provided a POS terminal for permitting a transaction indicating an amount that is less than a threshold amount, the POS terminal comprising: at least one processor; and at least one memory including computer program code; the at least one memory and the computer program code configured to, with the at least one processor, cause the POS terminal at least to: receive transaction data relating to the transaction, the transaction data indicating the amount; determine if the amount indicated in the transaction data is less than the threshold amount, the threshold amount referring to an amount that the POS terminal is authorised to permit; and permit the transaction to proceed in response to the determination if the amount is less than the threshold amount.

According to a second aspect, there is provided a payment network server comprising: at least one processor; and at least one memory including computer program code; the at least one memory and the computer program code configured to, with the at least one processor, cause the payment network server at least to: receive transaction data relating to a plurality of transactions; receive an identifier relating to the transaction data; determine if the received identifier matches an identifier in a register of identifiers each identifying a corresponding POS terminal; and identify a corresponding transaction data relating to each of the plurality of transactions when it is determined that the received identifier matches an identifier in the register.

According to a third aspect, there is provided a method for permitting a transaction indicating an amount that is less than a threshold amount, the method comprising: receiving transaction data relating to the transaction, the transaction data indicating the amount; determining if the amount indicated in the transaction data is less than the threshold amount; permitting the transaction to proceed in response to the determination if the amount is less than the threshold amount; storing the transaction data in a memory when the transaction is permitted to proceed; determining if a total amount is equal to or more than the threshold amount, the total amount relating to a sum of amounts indicated in one or more transactions that have been permitted and the amount indicated in the transaction data; and forwarding transaction data relating to the one or more transactions that have been permitted and the received transaction data to a payment network server when the total amount is equal to or more than the threshold amount, wherein the transaction data relating to the one or more transactions that have been permitted is received subsequent to a forwarding of transaction data.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 shows a block diagram of a system 100 in which a transaction indicating an amount that is less than a threshold amount is permitted to proceed;

FIG. 2a shows a flow diagram illustrating a method for permitting a transaction indicating an amount that is less than a threshold amount according to various embodiments;

FIG. 2b shows an illustration of how transactions can be permitted, by a POS terminal 102, to proceed according to various embodiments.

FIG. 3 shows a schematic diagram of a computer system suitable for use in executing the method depicted in FIG. 2 according to various embodiments;

FIG. 4 shows a schematic diagram of an exemplary computing device used to realise the POS terminal 102 shown in FIG. 1;

FIG. 5 shows a schematic of modules in payment network server 104 of FIG. 1 and how they function according to various embodiments; and

FIG. 6 shows a schematic of modules in the POS terminal 102 of FIG. 1 and how they function according to various embodiments.

### DETAILED DESCRIPTION

### Overview

Various embodiments provide devices and methods for permitting a transaction indicating an amount that is less than a threshold amount.

According to various embodiments, devices and methods are provided with which a transaction can be made using a payment account at a merchant POS (Point-of-Service) terminal, such that the transaction is permitted to proceed when it is determined that the amount indicated in the transaction is lesser than the threshold amount. The POS terminal accumulates these permitted transactions until a total amount of these transactions is equal to or more than the threshold amount and forwards data for these transactions to a payment network server. The payment network server then identifies, from the received data, data corresponding to each permitted transaction for further processing. Advantageously, the data relating to the permitted transactions is sent to the payment network server in a single forwarding, saving time and bandwidth as opposed to individually forwarding data for each transaction.

Further, the merchant incurs less processing cost and will be encouraged to allow consumers to use their payment account for transactions whose amount is lesser than the threshold amount. They also do not need to worry about handling cash of small denominations for returning change to the consumers. The consumer can now conveniently use their payment account without worrying about having insufficient cash on hand for such transactions. The payment facilitator associated with the payment network server will also enjoy more revenue from processing fees due to the increase in such transactions made using payment accounts.

In an example, a consumer uses a payment account to make a transaction at a merchant's POS terminal. The POS terminal receives transaction data relating to the transaction. The transaction data includes information such as an amount of the transaction. The POS terminal permits the transaction to proceed if the amount is less than a threshold amount.

When for example the POS terminal has permitted a plurality of transactions to proceed, such that a total amount of these transactions is equal to or more than the threshold amount, the POS terminal forwards data relating to the transactions to a payment network server.

The payment network server identifies, from the received data, data corresponding to each of the permitted transactions. Based on information provided in each identified transaction data, the payment network server identifies a respective issuer indicated in payment account information corresponding to a payment account used in each transaction and forwards each identified transaction data to the identified respective issuer for BAU (business as usual) processing. In BAU processing, the identified respective issuer checks the available funds or credit balance of the payment account used in the transaction and determines if the funds or credit balance are sufficient to pay the transaction amount indicated in the received transaction data. If it is determined that the funds or credit balance are sufficient, the issuer authorises the transaction and routes the authorisation response back to an acquirer server managing an account of the merchant. Otherwise, if the funds or credit balance are insufficient, the issuer declines the transaction and routes the rejection response to the acquirer server.

Advantageously, various embodiments can provide a big boost in terms of faster processing of transactions as well as enabling transactions to proceed in an offline environment. For example, the POS terminal can permit a transaction indicating an amount that is less than a threshold amount to proceed without needing to communicate with the payment network server, because the transaction can be permitted by the POS terminal to proceed without needing to send a request for transaction approval, through a payment network server, to an issuer of a payment account used in the transaction. There is also no need to receive, through a payment network server, an authorization response from the issuer in order to approve the transaction. In this case, an internet communication between the POS terminal and the payment network server is not required for the POS terminal to permit the transaction to proceed.

Advantageously, with the devices and methods according to various embodiments, consumers do not need to worry about having insufficient cash when making a transaction whose amount is less than the threshold amount. This is great usage for those who prefer cashless payments. Further, merchants are also freed from having to handle cash of small denominations in order to pay the correct change to consumers.

### Terms Description (in Addition to Plain and Dictionary Meaning of Terms)

A user device is a device that can be used by a consumer to initiate a transaction with a merchant. For example, when a user device is used to initiate a transaction with a POS terminal at a merchant store, a transaction request is sent from the user device to the POS terminal. The transaction request includes account details relating to a payment account.

In the following description, the term “payment account” may be associated with any suitable payment card such as a credit card, debit card, prepaid card, charge card, membership card, promotional card, frequent flyer card, identification card, gift card, and/or any other device that may hold payment account information such as computers, mobile devices like mobile phones, smartphones, personal digital assistants (PDAs), key fobs and other similar devices. Additionally or alternatively, a payment account may also be a digital wallet (which is also known as an e-wallet) which is typically used to store various forms of electronic money to aid in completing e-commerce transactions (or wallet-based transactions). For example, it is possible to link/register a payment card to a digital wallet to perform a wallet-based transaction. Recently, a digital wallet may also be implemented on a user device, such as a smart phone It will be understood that each type of these payment account can be used as a method of payment for performing a transaction with a merchant.

A POS terminal is an electronic device that can be used to process payments at retail locations such as a merchant store. For example, when a user device or payment card associated with a payment account is presented at the POS terminal for making a transaction, the POS terminal reads information off the user device or payment card and checks whether the funds or credit of the payment account used in the transaction is sufficient. If the check indicates that the funds or credit is sufficient, the POS terminal transfers funds from the payment account to the merchant's account for completing the transaction. The checking and transfer of funds is typically done via communication with a payment network server. The POS terminal is offered as a payment acceptance service by a payment service provider (PSP) to merchants in order to accept electronic payments by a variety of payment methods including the payment account. The PSP can connect to multiple acquiring banks, card, and payment networks in order to facilitate the day-to-day transactions at merchant stores. In various embodiments, the service for permitting a transaction indicating an amount less than a threshold amount may be provided by the PSP to the merchant.

A threshold amount is an amount that a POS terminal is authorized to permit. The POS terminal can undertake certain actions based on the outcome of a comparison between the threshold amount and a received transaction amount. For example, the POS terminal may allow the transaction to proceed if the transaction amount is less than the threshold amount. If the comparison indicates that the transaction amount is greater than or equal to the threshold amount, the POS terminal forwards the transaction to a payment network server for BAU processing. In BAU processing, the payment network server identifies an issuer of a payment account indicated in the received transaction data relating to the transaction and forwards the received transaction data to an issuer server of the identified issuer. The issuer server checks the available funds or credit balance of the payment account used in the transaction and determines if the funds or credit balance are sufficient to pay the transaction amount indicated in the received transaction data. If it is determined that the funds or credit balance are sufficient, the issuer authorises the transaction and routes the authorisation response back to an acquirer server managing an account of a merchant utilizing the POS terminal. Otherwise, if the funds or credit balance are insufficient, the issuer declines the transaction and routes the rejection response to the acquirer server. The threshold amount may be set by the merchant or a payment network server. In an embodiment, the payment network server may set a threshold amount for the POS terminal based on past transaction history of the POS terminal. For example, if the past transaction history indicates a high volume of transactions with a transaction amount of $X and a low volume of transactions with a transaction amount of $(X+10), the payment network server may set the threshold value such that it is higher than $X but lower than $(X+10). Advantageously, transactions with transaction amount of $X may now be permitted to proceed, reducing processing time and allowing faster transactions for the merchant.

### Exemplary Embodiments

Embodiments will be described, by way of example only, with reference to the drawings. Like reference numerals and characters in the drawings refer to like elements or equivalents.

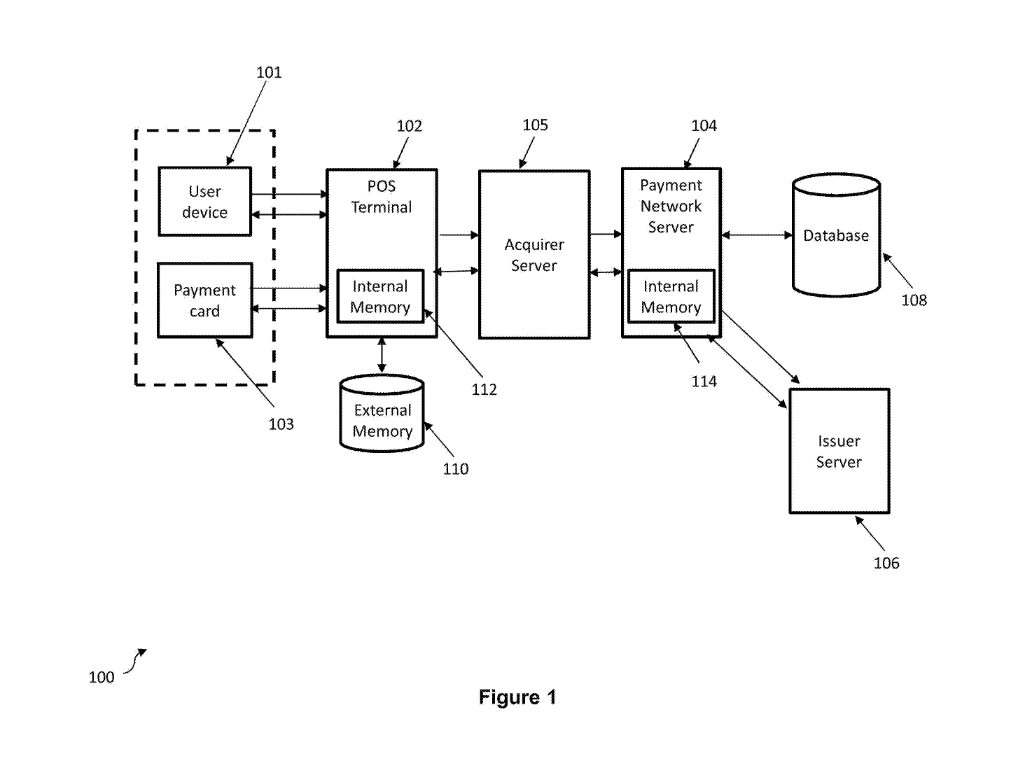

FIG. 1 illustrates a block diagram of a system 100 in which a transaction indicating an amount that is less than a threshold amount is permitted to proceed, in accordance with an embodiment of the invention. In this system 100, a payment account is used to initiate the transaction at a POS terminal 102. In an embodiment, the payment account is a digital wallet executing on a user device 101. In yet another embodiment, the payment account is a payment card 103 such as, for example, a credit card or debit card.

The system 100 comprises a POS terminal 102 in communication with a payment network server 104. The payment network server 104, in turn, is in communication with an issuer server 106.

Use of the term ‘server’ herein can mean a single computing device or a plurality of interconnected computing devices which operate together to perform a particular function. That is, the server may be contained within a single hardware unit or be distributed among several or many different hardware units.

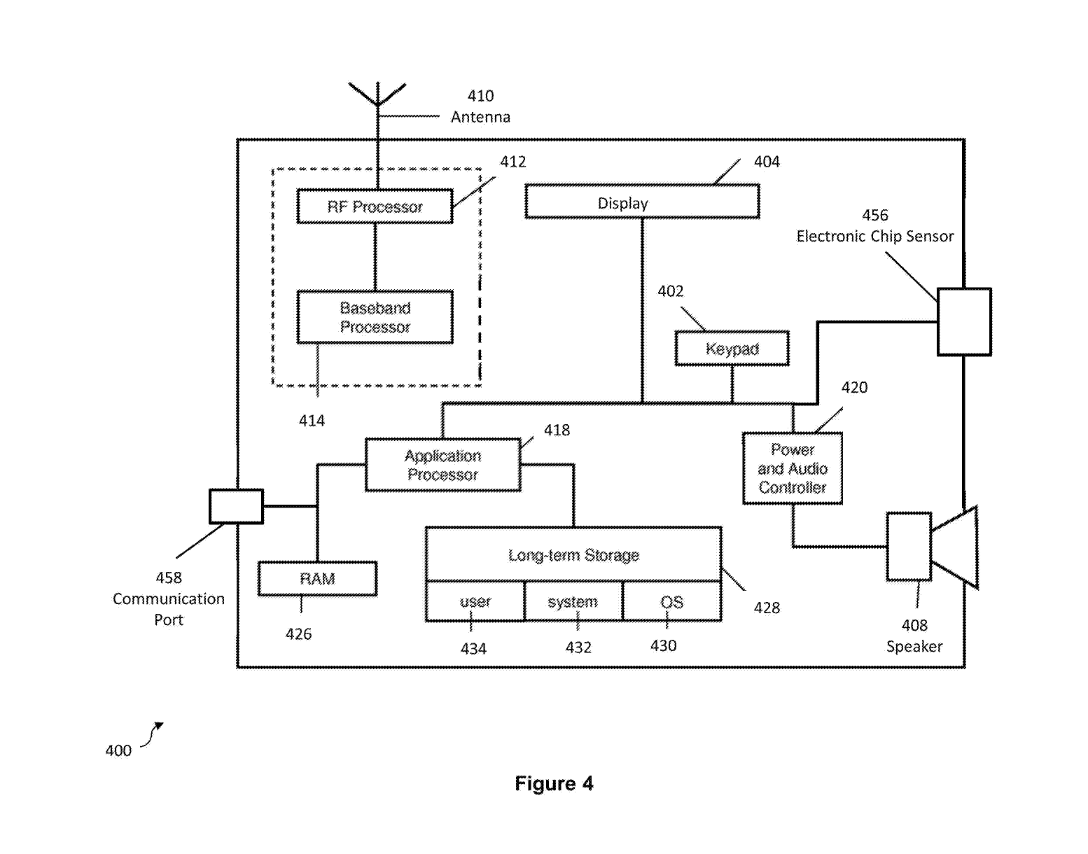

The POS terminal 102 typically is associated with a merchant who is a party to a transaction that occurs between the consumer and the merchant. An exemplary POS terminal 102 is shown in FIG. 4. The POS terminal 102 is capable of receiving transaction data relating to a transaction, the transaction data including an amount of the transaction. The transaction data may also include payment account information such as a PAN of a payment account used in the transaction. The transaction data may further include a Personal Identification Number (PIN), Card Verification Code (CVC) and/or digital signature provided by the consumer for the payment account. In the system 100, the POS terminal 102 is one that is modified to permit transactions whose amount is lesser than a threshold amount to proceed. For example, a software application may be installed in the POS terminal 102, or the firmware of the POS terminal 102 may be upgraded, such that the POS terminal 102 may be configured to determine whether the amount of the transaction is lesser than the threshold amount. The software application may be managed by a POS server that is connected to the POS terminal 102 to a private or internal network like a virtual private network (VPN).

If it is determined that the amount is less than the threshold amount, the POS terminal 102 may permit the transaction to proceed without needing to communicate with the payment network server 104. This is because the transaction can be permitted by the POS terminal 102 to proceed without needing to send a request for transaction approval, through a payment network server 104 to an issuer of a payment account used in the transaction. There is also no need to receive, through a payment network server 104, an authorization response from the issuer server 106 in order to approve the transaction. In this case, an internet communication between the POS terminal 102 and the payment network server 104 is not required for the POS terminal 102 to permit the transactions to proceed.

Then, instead of forwarding the transaction data to the payment network server 104 immediately, the POS terminal 102 may store the received transaction data in an internal memory 112 or external-based memory 110 and continue to process transactions. The external-based memory 110 may be, for example, a database server or an external hard disk drive that the POS terminal 102 can access via a wired or wireless connection to read or write data, such as transaction data relating to transactions that are permitted to proceed by the POS terminal 102. When the POS terminal 102 has permitted a number of transactions to proceed, such that the total amount relating to these permitted transactions is determined by the POS terminal 102 to be equal to or more than the threshold amount, the POS terminal 102 forwards the transaction data of the permitted transactions to the payment network server 104 for further processing. The POS terminal 102 may first determine if there is an internet connection with the payment network server 104 before forwarding the transaction data. For example, if the POS terminal 102 is not connected to the internet for example via an Ethernet cable or wireless network connection, it may search for a wireless internet network that it can access. If it is unable to find an accessible wireless network after searching a number of times, the POS terminal 102 may provide an indicator, for example on a display screen of the POS terminal 102, that an internet connection to the payment network server 104 is not available. The POS terminal 102 may continue to store the transaction data relating to the permitted transactions until an internet connection for connecting to the payment network server 104 is available.

In various embodiments, the POS terminal 102 may first forward the transaction data to an acquirer server 105. An acquirer associated with the acquirer server 105 is a financial institution that manages an account of a merchant utilising the POS terminal 102. The acquirer server 105 may help to forward the received transaction data to the payment network server 104 by converting the received transaction data into a required format, for example an IPM message. IPM (integrated product message) messages are used in Mastercard's Global Clearing Management System (GCMS) for clearing transactions between issuers and acquirers which a person skilled in the art will appreciate. For example, when an acquirer server 105 submits a transaction to a payment network server 104 to clear the transaction, an IPM message containing information of the transaction is sent from the acquirer server 105 to the payment network server 104. The GCMS validates the transaction information in the IPM message and forwards the information to an issuer server 106, wherein the issuer associated with the issuer server 106 is identified based on the transaction information. The issuer server 106 then prepares data based on the received transaction information for updating the payment account statement and clearing the transaction. The issuer may also send IPM messages to the acquirer server 105 via the payment network server 104 for chargeback purposes, in the event that the received transaction information is found by the issuer server 106 to be invalid. In various embodiments, the POS terminal 102 may include an identifier identifying the POS terminal 102 into the transaction data before forwarding to the payment network server 104.

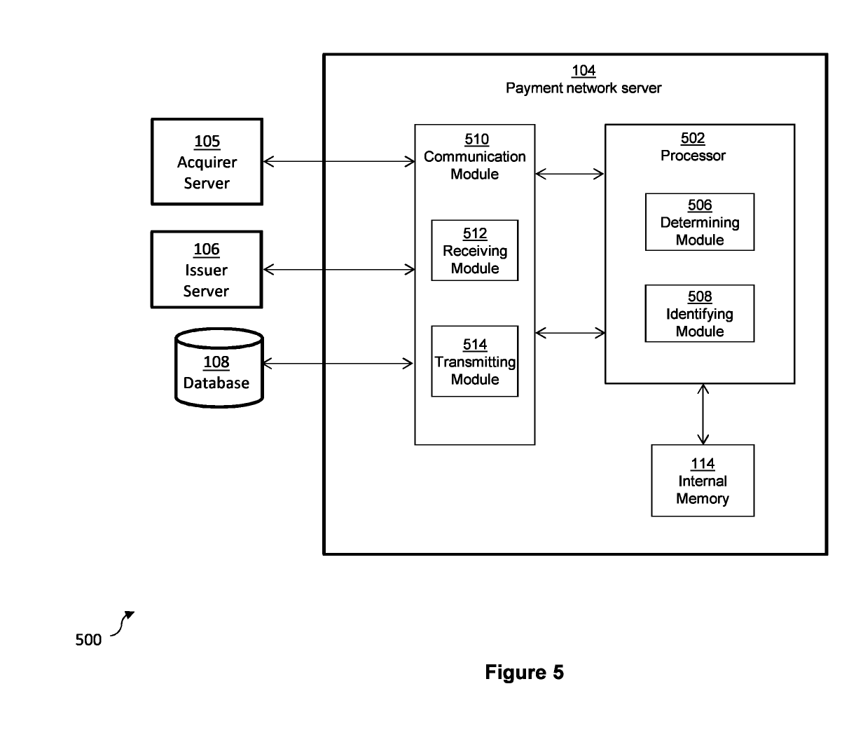

The payment network server 104 typically is associated with a payment facilitator. For example, the payment network server 104 may be the Banknet® network operated by Mastercard®. The payment facilitator (e.g. Mastercard®) may be an entity (e.g. a company or organization) who operates to process transactions, clear and settle funds for payments between two entities (e.g. two banks). The payment network server 104 may include one or more computing devices that are used for processing transactions. An exemplary payment network server 104 is shown in FIG. 5. Before the payment network server 104 can facilitate a transaction as shown in the system 100, the payment network server 104 needs to be configured such that it can communicate and exchange data with the issuer server 106 and the POS terminal 102 with regards to handling transaction data relating to the permitted transactions. Therefore, a software application that grants the abovementioned functions may be installed into the payment network server 104. In the system 100, the payment network server 104 is configured to receive data from the POS terminal 102, whereby such data relates to a plurality of transactions that were permitted to proceed by the POS terminal 102. The payment network server 104 identifies, from the received data, transaction data corresponding to each of the plurality of permitted transactions. The payment network server 104 is also configured to determine, from the identified transaction data, a respective issuer facilitating each of the plurality of transactions, and forward the identified transaction data for each of the plurality of transactions to the respective determined issuer. In this case, at least one of the determined issuers is the issuer associated with the issuer server 106. The payment network server 104 may also be configured to set the threshold amount of the POS terminal 102 based on transaction history of the POS terminal 102.

The issuer server 106 generally is associated with an issuer and may include one or more computing devices that are used to perform or process a transaction, such as a transaction relating to transaction data received from the payment network server 104. The issuer may be an entity (e.g. a company, organization or financial institution) which issues (e.g. establishes, manages, administers) a transaction credential or an account (e.g. a financial bank account), or issues credit and debit cards to consumers on behalf of card networks such as Mastercard®. The issuer maintains a bank account associated with the issued credit or debit card and processes credit or debit payments to and from the bank account. In the system 100, the payment account used to pay for the transaction indicating an amount that is lesser than the threshold amount of the POS terminal 102 is issued by the issuer associated with the issuer server 106.

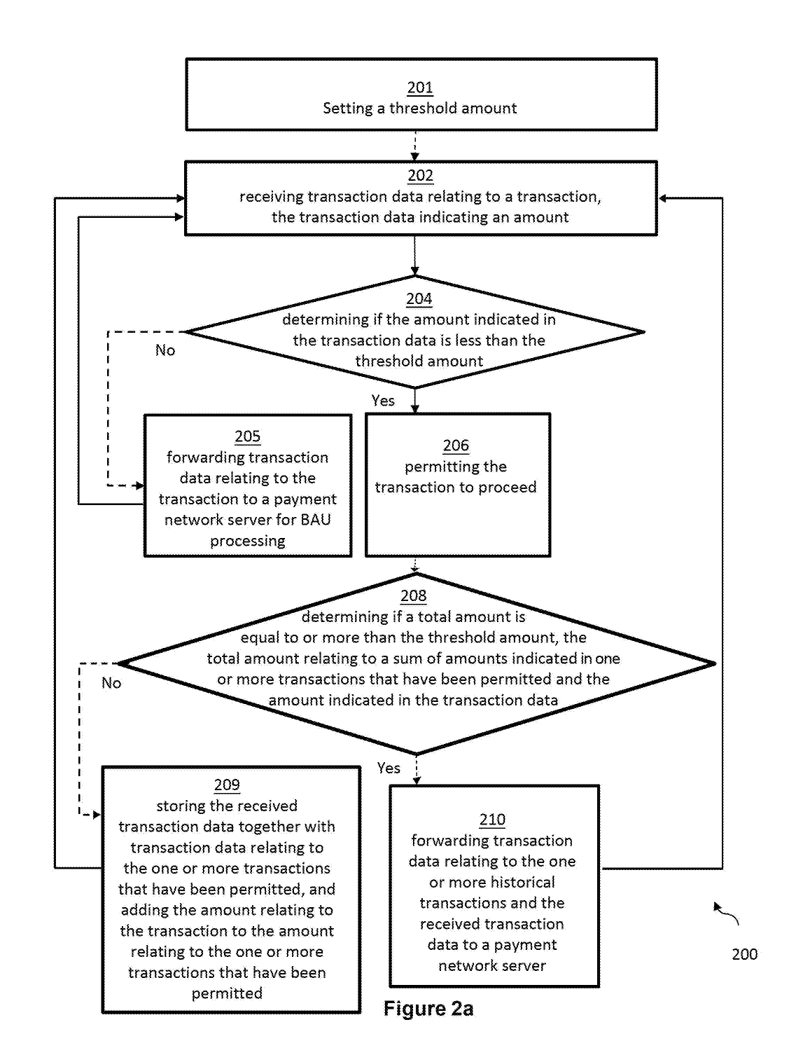

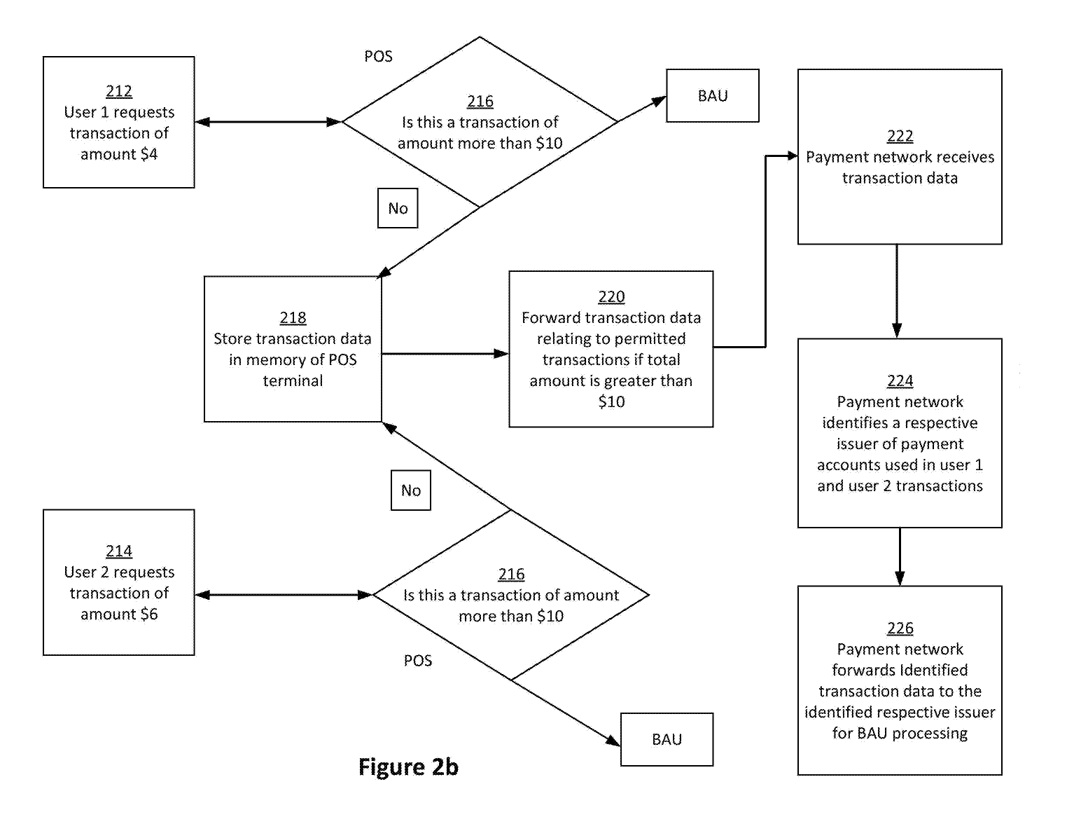

The payment network server 104 may be configured to communicate with, or may include, a database 108. The database 108 may store data corresponding to a payment account. Examples of the data include account number, PIN, CVC, digital signature, transaction history, data corresponding to the payment account owner information such as name, gender, home address, email address, occupation, income details, identity card number, passport number, marital status, age group and other information that may be registered with the payment network server 104 and issuer server 106 in order to identify the payment account owner. The database 108 may also store data that allows the payment network server 104 to identify the POS terminal 102 based on the identifier added in the transaction data by the POS terminal 102. For example, in embodiments where the identifier is a PAN issued by the payment network server 104 to the POS terminal 102, the database 108 may store a register of BIN ranges that is allocated for such PAN. The payment network server 104 may determine whether a received PAN is one that is issued to a POS terminal by checking if the PAN is within the BIN range stored in the database 108. Alternatively, the payment network server 104 may store the above mentioned data in an internal memory 114 of the payment network server 104. Further details on how these data are managed are described in FIG. 2 below.

FIG. 2 shows a flow chart 200 illustrating a method for permitting a transaction indicating an amount that is less than a threshold amount.

At step 201, a threshold amount for the POS terminal 102 is set. The threshold amount refers to an amount that the POS terminal 102 is authorised to permit. The threshold amount may be set by the merchant or the payment network server 104. In an embodiment, the payment network server 104 may set a threshold amount for the POS terminal 102 based on past transaction history of the POS terminal 102. For example, if the past transaction history indicates a high volume of transactions with a transaction amount of $X and a low volume of transactions with a transaction amount of $(X+10), the payment network server 104 may set the threshold value such that it is higher than $X but lower than $(X+10). Advantageously, transactions with transaction amount of $X may now be permitted to proceed, reducing processing time and allowing faster transactions at the POS terminal 102.

At step 202, the POS terminal 102 receives transaction data relating to a transaction, the transaction data including account information relating to a payment account. In an embodiment, the payment account may be a digital wallet application executing on a user device 101. In another embodiment, the payment account may be a payment card 103 such as credit card or debit card. For example, a consumer seeking to use a payment account to make payment may initiate a transaction by presenting his or her user device 101 at the POS terminal 102, where a transaction request is sent from the user device 101 to the POS terminal 102, the transaction request including account details relating to the payment account. In an embodiment where the payment account is a payment card 103, the payment card 103 may be inserted into an input slot of the POS terminal 102, so that the POS terminal 102 may retrieve information such as a PAN of the payment account associated with the payment card 103. The POS terminal 102 may also be able to retrieve such information from the user device 101 or payment card 103 via an inbuilt NFC transceiver or sensor utilising technologies similar to, for example, Mastercard Contactless, whereby the payment account information is read from the user device 101 or payment card 103 by placing the user device 101 or payment card 103 in proximity with the NFC transceiver or sensor. When utilising the NFC transceiver of the POS terminal 102 as mentioned above, an internet-based communication between the POS terminal 102 and the user device 101 or the payment card 103 is not required. Advantageously, such a way of payment is still possible even if the POS terminal 102 is situated in a location with weak or unstable internet access.

A transaction amount that is to be paid by the digital wallet account executing on the user device 101 or by payment card 103 may be input directly to the POS terminal 102 via an inbuilt keypad of the POS terminal 102. The transaction amount may also be retrieved by scanning, with a barcode scanner, a barcode representing a good or service that the transaction is paying for. The scanned barcode may then be used to check a good or service database of the merchant to retrieve information of the good or service that is to be paid for, the information including the transaction amount payable for the good and/or service. The transaction data received by the POS terminal 102 includes the transaction amount. It may include other information such as the PAN of the payment account used in the transaction.

In an embodiment, the POS terminal 102 may determine if the payment account used for the transaction is one that is subscribed to a service for permitting transactions to proceed. This determination step may be required if the enablement of permitting transactions to proceed is provided as a service with which the payment account has to be subscribed. For example, this service may be requested for enrolment by the payment account owner or extended to the owner as a value-added service. The service may be provided by a third party service provider, the issuer associated with the issuer server 106 or the payment facilitator associated with the payment network server 104. The eligibility to enjoy this service may be subject to the payment account owner's past transaction history which the service provider may check to ensure that the payment account owner is unlikely to default on payment for a permitted transaction.

In such a scenario, the POS terminal 102 may only proceed to step 204 when it is determined that the payment account is subscribed to the required service. In another embodiment, the service for permitting transactions may be provided by a PSP that operates the POS terminal 102 to the merchant utilising the POS terminal 102. In this case, a check may be made by the POS terminal 102 to determine if the merchant is subscribed to the service before it permits a transaction. If it is determined that the merchant did not subscribe to the service, the POS terminal 102 may simply process the received transaction according to the standard BAU processing. In BAU processing, the POS terminal 102 forwards the received transaction data relating to the requested transaction to the payment network server 104. The payment network server 104 identifies an issuer of a payment account indicated in the received transaction data relating to the transaction and forwards the received transaction data to an issuer server 106 of the identified issuer. The issuer server 106 checks the available funds or credit balance of the payment account used in the transaction and determines if the funds or credit balance are sufficient to pay the transaction amount indicated in the received transaction data. If it is determined that the funds or credit balance are sufficient, the issuer server 106 authorises the transaction and routes the authorisation response back to an acquirer server 105 that manages an account of the merchant utilizing the POS terminal 102. Otherwise, if the funds or credit balance are insufficient, the issuer server 106 declines the transaction and routes the rejection response to the acquirer server 105.

At step 204, the POS terminal 102 determines if the amount indicated in the transaction data is less than the threshold amount. If the amount is determined to be equal to or greater than the threshold amount, the POS terminal 102 performs step 205 of method 200, wherein transaction data relating to the transaction received at step 202 may be forwarded to the payment network server 104 for BAU processing. In BAU processing, the POS terminal 102 forwards the received transaction data relating to the requested transaction to the payment network server 104. The payment network server 104 identifies an issuer of a payment account indicated in the received transaction data relating to the transaction and forwards the received transaction data to an issuer server 106 of the identified issuer. The issuer server 106 checks the available funds or credit balance of the payment account used in the transaction and determines if the funds or credit balance are sufficient to pay the transaction amount indicated in the received transaction data. If it is determined that the funds or credit balance are sufficient, the issuer server 106 authorises the transaction and routes the authorisation response back to an acquirer server 105 that manages an account of the merchant utilizing the POS terminal 102. Otherwise, if the funds or credit balance are insufficient, the issuer server 106 declines the transaction and routes the rejection response to the acquirer server 105. After forwarding the transaction data relating to the transaction received at step 202 to the payment network server 104, the POS terminal 102 repeats steps 202 to 204 of the method 200 for each additional transaction that it receives in FIG. 2a.

If, on the other hand, it is determined that the amount relating to the transaction received at step 202 is less than the threshold amount, the POS terminal 102 may permit the transaction to proceed i.e. step 206. At step 206, the transaction is permitted to proceed in response to the determination (as shown in step 204) if the transaction amount is less than the threshold amount. In other words, the POS terminal 102 approves the transaction and the consumer is allowed to have the good and/or service, if it is determined that the transaction amount is less than the threshold amount. Advantageously, the POS terminal 102 need not be connected to a network such as the internet or the payment network server 104 to permit a transaction. This is because the transaction indicating an amount less than the threshold amount can be permitted by the POS terminal 102 locally without needing to request and receive, through the payment network server 104, transaction approval from an issuer of the payment account used for the permitted transaction. In this case, an internet communication between the POS terminal 102 and the payment network server 104 is not required for the POS terminal 102 to permit transactions to proceed. Therefore, a merchant can also utilise the POS terminal 102 in places with weak or unstable internet connections.

After step 206, the POS terminal 102 may perform step 208 to determine if a transaction permitted at step 206 results in a determination that a total amount is equal to or more than the threshold amount. The total amount is the sum of the amounts relating to one or more transactions that have been permitted and an amount relating to the transaction permitted at step 206. The one or more transactions that have been permitted refer to one or more transactions that are previously permitted by the POS terminal 102 to proceed, subsequent to a forwarding of transaction data from the POS terminal 102 to the payment network server 104.

If it is determined that the total amount is less than the threshold amount, step 209 is performed whereby the transaction data relating to the transaction may be stored in an internal memory 112 of the POS terminal 102 or an external database together with the one or more transactions that have been permitted. Transaction data relating to the one or more transactions that have been permitted may be stored by the POS terminal 102 in its internal memory 112 or an external memory 110. The transaction data of the one or more transactions that have been permitted also include respective payment amounts for each of these transactions. The POS terminal 102 also adds the transaction amount into a sum of the transaction amounts relating to the transactions that have been permitted, such that the sum of amounts relating to the transactions that have been permitted is increased by the amount relating to the transaction permitted at step 206. In other words, the transaction permitted at step 206 is now considered as one of the one or more transactions that have been permitted.

At step 210, in response to the determination that the total amount is equal to or greater than the threshold amount, the POS terminal 102 forwards the transaction data relating to the transactions that have been permitted and the transaction data relating to the transaction permitted at step 206 to the payment network server 104. These transaction data may be received by the payment network server 104 in a single forwarding, similar to receiving transaction data relating to a single transaction. In order to forward these transaction data to the payment network server 104, the POS terminal 102 may be configured to create an IPM (Integrated Product Message) message that includes a header portion and a PDS (Private Data Sub element) portion. The transaction data relating to the plurality of transactions (comprising the transactions that have been permitted and the transaction permitted at step 206) may be populated in the PDS portion. In various embodiments, the POS terminal 102 may also populate account details relating to an account belonging to the merchant into the IPM message in order for payment to be made to the account. In this case, the merchant may store account details relating to the account in the internal memory 112 of the POS terminal 102 or an external memory 110 that the POS terminal 102 may access. The IPM message containing the transaction data may then be forwarded to the payment network server 104. The payment network server 104 may be configured to identify, from the received transaction data in the PDS portion of the IPM message, corresponding transaction data for each of the plurality of transactions. A respective issuer may be determined for each transaction based on information provided in each identified transaction data. For example, each identified transaction data may include a PAN of a payment account used in each respective transaction. Based on the PAN, the payment network server 104 may identify the issuer of the payment account associated with the PAN and forward the identified transaction data of the respective transaction to a server 106 of the identified issuer for BAU processing.

In various embodiments, the POS terminal 102 may first forward the transaction data to an acquirer server 105. An acquirer associated with the acquirer server 105 is a financial institution that manages an account of a merchant associated with the POS terminal 102. The acquirer server 105 may help to forward the received transaction data to the payment network server 104 by converting the received transaction data into a required format, such as the IPM message format as explained above.

In various embodiments, the POS terminal 102 may, in response to the determination that the amount relating to the transaction received at step 202 is greater than the threshold amount, forward the transaction data relating to both the transaction received at step 202 and the transactions that have been permitted to the payment network server 104. This is possible because if the amount relating to the transaction received at step 202 is greater than the threshold amount, it follows that the sum of the amount relating to the transaction received at step 202 and the transactions that have been permitted will also be greater than the threshold amount. In this case, however, the transaction received at step 202 is not permitted by the POS terminal 102 to proceed (since the amount is greater than the threshold amount) and will have to go through the BAU processing via the payment network server 104.

In various embodiments, the POS terminal 102 may be configured to include an identifier identifying the POS terminal 102 with the transaction data before forwarding to the payment network server 104. For example, the POS terminal 102 may include such an identifier into the header portion of the IPM message as mentioned above. The identifier may enable the payment network server 104 to differentiate between transaction data relating to normal transactions and transaction data relating to a plurality of transactions, such as transaction data relating to the transaction permitted at step 206 and the one or more transactions that have been permitted from the POS terminal 102.

In various embodiments, only transaction data relating to a plurality of transactions (such as the transaction permitted at step 206 and transactions that have been permitted) may have the identifier. In this case, the identifier is not included with transaction data relating to a single transaction, such as one whose amount is greater than the threshold amount and where the transaction data is forwarded to the payment network server 104 without inclusion of data relating to the transactions that have been permitted by the POS terminal 102. Therefore, the payment network server 104 may determine whether a received transaction data is for a plurality of transactions based on a presence of an identifier in the received transaction data.

In various embodiments, the payment network server 104 may be configured to compare the received identifier with a register of identifiers in order to determine whether the received transaction data is relating to a plurality of transactions, whereby the register of identifiers may be stored in the database 108 or the internal memory 114 of the payment network server 104. This comparison with a register may be necessary in the case where the identifier is currently used in the state of the art for forwarding transaction data to payment network servers, such that all transaction data received by the payment network server 104 contains a variation of such an identifier. For example, the identifier may be a PAN that is issued by the payment network server 104 to the POS terminal 102. The POS terminal 102 may be configured to include its PAN into the header portion of the IPM message as mentioned above. This PAN may belong to a special BIN range that is allocated for PANs that are issued to POS terminals, where such POS terminals are modified for permitting transactions to proceed. This BIN range may be stored in the database 108 or the internal memory 114 of the payment network server 104. The payment network server 104 may thus refer to the BIN range to determine if the PAN included in the received transaction data is one that is issued to a POS terminal. If so, the payment network server 104 may confirm that the received transaction data is relating to a plurality of transactions and thus proceed to identify, from the received transaction data, transaction data corresponding to each of the plurality of transactions.

After identifying a respective issuer for each of the plurality of transactions, the payment network server 104 can then forward each identified transaction data to servers of the identified respective issuers, such as the issuer server 106. Subsequently, the issuer server 106 processes the received transaction data in a BAU manner, for example by checking a balance or credit limit of a payment account associated with a PAN included with the transaction data, comparing the balance or credit limit with a required payment amount as indicated in the transaction data and crediting the payment amount from the payment account to a merchant account as indicated in the transaction data based on the outcome of the comparison.

After forwarding the transaction data relating to the transactions that have been permitted and the transaction permitted at step 206 to the payment network server 104, the POS terminal 102 repeats steps 202 to step 208 of the method of FIG. 2a again.

A flow chart of the above method according to various embodiments is also shown in FIG. 2b. User 1 initiates a transaction having a transaction amount of $4 at step 212. For example, the user 1 may initiate a transaction at a POS terminal 102 in a merchant stall by presenting his or her user device (such as the user device 101) or payment card (such as the payment card 103) for the transaction amount of $4. Transaction data relating to the transaction initiated by user 1 is received by the POS terminal 102, where the transaction data indicates a transaction amount of $4.

At step 216, the POS terminal 102 determines if the transaction amount relating to the transaction requested by user 1 is greater than a threshold amount. In the embodiment presented by the flow diagram of FIG. 2b, the threshold amount is set as $10. In this case, if it is determined that the transaction amount indicated in the received transaction data is greater than $10, the POS terminal 102 forwards the transaction data to a payment network server 104 for BAU processing. In BAU processing, the POS terminal 102 forwards the received transaction data relating to the requested transaction to the payment network server 104. The payment network server 104 identifies an issuer of a payment account indicated in the received transaction data relating to the transaction and forwards the received transaction data to an issuer server 106 of the identified issuer. The issuer server 106 checks the available funds or credit balance of the payment account used in the transaction and determines if the funds or credit balance are sufficient to pay the transaction amount indicated in the received transaction data. If it is determined that the funds or credit balance are sufficient, the issuer server 106 authorises the transaction and routes the authorisation response back to an acquirer server 105 that manages an account of the merchant utilizing the POS terminal 102. Otherwise, if the funds or credit balance are insufficient, the issuer server 106 declines the transaction and routes the rejection response to the acquirer server 105.

On the other hand, if it is determined that the transaction amount indicated in the received transaction data relating to the transaction is less than or equal to $10, the POS terminal 102 permits the transaction and the received transaction data is stored in an internal memory 112 or external-based memory 110 of the POS terminal 102. The transaction requested by user 1 has a transaction amount of $4 which is less than the threshold amount of $10. Therefore, the POS terminal 102 permits the transaction of user 1 and, at step 218, stores the received transaction data in an internal memory 112 or external-based memory 110 of the POS terminal 102.

After the transaction requested by user 1 is permitted to proceed by the POS terminal 102, a user 2 requests, at step 214, a transaction at the POS terminal 102 with a transaction amount of $6. For example, the user 2 may initiate a transaction at the POS terminal 102 by presenting his or her user device (such as the user device 101) or payment card (such as the payment card 103) for transaction amount of $6. Transaction data relating to the transaction initiated by user 2 is received by the POS terminal 102, where the transaction data indicates a transaction amount of $6. The POS terminal 102 then determines, at step 216, if the transaction amount indicated in the received transaction data relating to the transaction requested by user 2 is greater than the threshold amount. Since the transaction amount of $6 is less than the threshold amount of $10, the POS terminal 102 permits the transaction to proceed and, at step 218, stores the transaction data relating to the user 2 transaction in the internal memory 112 or external-based memory 110 of the POS terminal 102.

At step 220, the POS terminal 102 determines if a total amount of the permitted transactions is more than the threshold amount. In the present embodiment, the total amount is a sum of the amounts relating to one or more transactions that have been permitted to proceed, subsequent to a forwarding of transaction data to the payment network server 104. Assuming that there are no transactions permitted by the POS terminal 102 before the transaction requested by user 1, the total amount is the sum of the transaction amounts relating to the transactions by user 1 ($4) and user 2 ($6), which adds up to $10. Since the total amount of $10 is equal to the threshold amount, the POS terminal 102 forwards, at step 220, the transaction data relating to the transactions of user 1 and user 2 to the payment network server 104.

At step 222, the payment network server receives the transaction data forwarded by the POS terminal 102. These transaction data may be received by the payment network server 104 in a single forwarding, similar to receiving transaction data relating to a single transaction. In order to forward these transaction data to the payment network server 104, the POS terminal 102 may be configured to create an IPM (Integrated Product Message) message that includes a header portion and a PDS (Private Data Sub element) portion. The transaction data relating to the plurality of transactions (comprising the transactions of user 1 and user 2 which have been permitted to proceed by the POS terminal 102) may be populated in the PDS portion. In various embodiments, the POS terminal 102 may also populate account details relating to an account belonging to the merchant utilising the POS terminal 102 into the IPM message in order for payment to be made to the account. In this case, the merchant may store account details relating to the account in the internal memory 112 of the POS terminal 102 or an external memory 110 that the POS terminal 102 may access. The IPM message containing the transaction data may then be forwarded to the payment network server 104. The payment network server 104 may be configured to identify, from the received transaction data in the PDS portion of the IPM message, corresponding transaction data for each of the plurality of transactions. A respective issuer may be determined for each transaction based on information provided in each identified transaction data, for example at step 224 of the flow diagram of FIG. 2b. For example, each identified transaction data may include a PAN of a payment account used in each respective transaction. Based on the PAN, the payment network server 104 may identify the issuer of the payment account associated with the PAN and forward, at step 226, the identified transaction data of the respective transaction to a server 106 of the identified issuer for BAU processing.

In various embodiments, the POS terminal 102 may first forward the transaction data to an acquirer server 105. An acquirer associated with the acquirer server 105 is a financial institution that manages an account of a merchant associated with the POS terminal 102. The acquirer server 105 may help to forward the received transaction data to the payment network server 104 by converting the received transaction data into a required format, such the IPM message format as explained above.

In various embodiments, the POS terminal 102 may be configured to include an identifier identifying the POS terminal 102 with the transaction data before forwarding to the payment network server 104. For example, the POS terminal 102 may include such an identifier into the header portion of the IPM message as mentioned above. The identifier may enable the payment network server 104 to differentiate between transaction data relating to normal transactions and transaction data relating to a plurality of transactions, such as transaction data relating to the user 1 and user 2 transactions which are permitted to proceed by the POS terminal 102.

In various embodiments, only transaction data relating to a plurality of transactions (such as the user 1 and user 2 transactions) may have the identifier. In this case, the identifier is not included with transaction data relating to a single transaction, such as one whose amount is greater than the threshold amount and where the transaction data is forwarded to the payment network server 104 without inclusion of data relating to the transactions that have been permitted by the POS terminal 102. Therefore, the payment network server 104 may determine whether a received transaction data is for a plurality of transactions based on a presence of an identifier in the received transaction data.

In various embodiments, the payment network server 104 may be configured to compare the received identifier with a register of identifiers in order to determine whether the received transaction data is relating to a plurality of transactions, whereby the register of identifiers may be stored in the database 108 or the internal memory 114 of the payment network server 104. This comparison with a register may be necessary in the case where the identifier is currently used in the state of the art for forwarding transaction data to payment network servers, such that all transaction data received by the payment network server 104 contains a variation of such an identifier. For example, the identifier may be a PAN that is issued by the payment network server 104 to the POS terminal 102. The POS terminal 102 may be configured to include its PAN into the header portion of the IPM message as mentioned above. This PAN may belong to a special BIN range that is allocated for PANs that are issued to POS terminals, where such POS terminals are modified for permitting transactions to proceed. This BIN range may be stored in the database 108 or the internal memory 114 of the payment network server 104. The payment network server 104 may thus refer to the BIN range to determine if the PAN included in the received transaction data is one that is issued to a POS terminal. If so, the payment network server 104 may confirm that the received transaction data is relating to a plurality of transactions and thus proceed to identify, from the received transaction data, transaction data corresponding to each of the plurality of transactions.

After identifying a respective issuer of the respective payment account used in the user 1 and user 2 transactions at step 224, the payment network server 104 may then forward, at step 226, each identified transaction data relating to the user 1 and user 2 transactions to servers of the identified respective issuers, such as the issuer server 106. Subsequently, the issuer server 106 processes the received transaction data in a BAU manner, for example by checking a balance or credit limit of a payment account associated with a PAN included with the transaction data, comparing the balance or credit limit with a required payment amount as indicated in the transaction data and crediting the payment amount from the payment account to a merchant account as indicated in the transaction data based on the outcome of the comparison.

Advantageously, use of the POS terminal 102 for permitting transactions to proceed can allow for faster transactions at a merchant store, since approval is not required from the payment network server 104 and the issuer server 106. This also frees up processing power of both servers that would otherwise be used to process the transactions.

Advantageously, the single forwarding of transaction data relating to a plurality of transactions from the POS terminal 102 to the payment network server 104 can reduce bandwidth usage and processing power as opposed to forwarding the data one transaction at a time. It is also beneficial in terms of processing fees incurred by the merchant associated with the POS terminal, since the merchant is only charged a processing fee for a single transaction, in order to process the plurality of transactions.

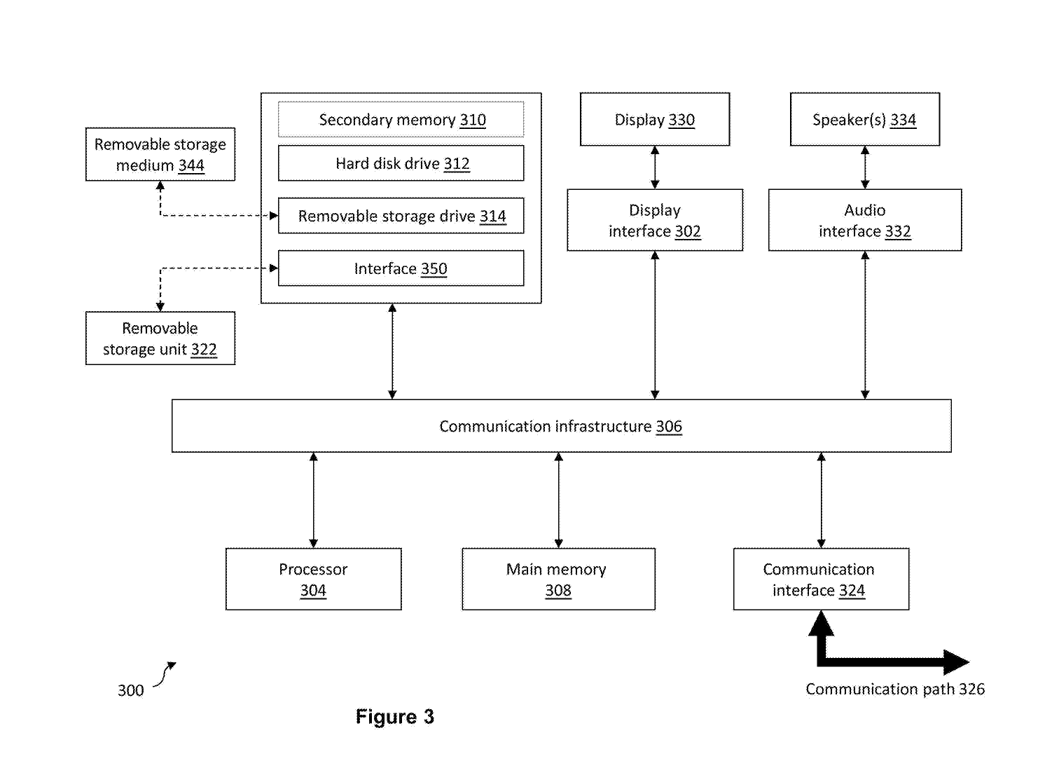

FIG. 3 depicts an exemplary computing device 300, hereinafter interchangeably referred to as a computer system 300, where one or more such computing devices 300 may be used to implement the system 100 of FIG. 1 and FIG. 2. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 350. Examples of a removable storage unit 322 and interface 350 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 350 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the inventions, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the storage drive 312, or the interface 350. The computer program product may be a non-transitory computer readable medium. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

FIG. 4 is a schematic of a computing device 400 that may be utilized to implement the POS terminal 102 shown in FIG. 1.

The computing device 400 comprises a keypad 402, a display 404, a speaker 408 and an antenna 410. Communication hardware that is used to enable NFC communication with the payment card is represented by RF processor 412 which provides an RF signal to the antenna 410 for the transmission of data signals, and the receipt therefrom. Additionally provided is a baseband processor 414, which provides signals to and receives signals from the RF processor 412.

The keypad 402 and the display 404 are controlled by an application processor 418. The keypad 402 can be used to adjust settings for the POS terminal 102 such as setting the threshold amount. The keypad 402 can also be used to input a transaction amount. The display 404 can be used to provide an indication of the status of the POS terminal 102, such as payment options available when the POS terminal 102 detects that it is being used to receive electronic payment, or that the POS terminal 102 is processing payment after a transaction amount is input through the keypad 402, or that the transaction is permitted to proceed according to various embodiments. A power and audio controller 420 is provided to supply power to the RF processor 412 and the baseband processor 414, the application processor 418, and other hardware. The power and audio controller 420 also controls audio output via the speaker 408. The speaker 408 can be used to provide sounds to indicate that a data transaction with the POS terminal 102 has been successfully completed.

In order for the application processor 418 to operate, various different types of memory are provided. Firstly, the computing device 400 includes Random Access Memory (RAM) 426 connected to the application processor 418 into which data and program code can be written and read from at will. Code placed anywhere in RAM 426 can be executed by the application processor 418 from the RAM 426. RAM 426 represents a volatile memory of the computing device 400.

Secondly, the computing device 400 is provided with a long-term storage 428 connected to the application processor 418. The long-term storage 428 comprises three partitions, an operating system (OS) partition 430, a system partition 432 and a user partition 434. The long-term storage 428 represents a non-volatile memory of the computing device 400.

In the present example, the OS partition 430 contains the firmware of the computing device 400 which includes an operating system. Other computer programs may also be stored on the long-term storage 428, such as application programs, and the like. In particular, application programs which are mandatory to the computing device 400 are typically stored in the system partition 432. The application programs stored on the system partition 432 would typically be those which are bundled with the computing device 400 by the device manufacturer when the computing device 400 is first sold. Application programs which are added to the computing device 400 by the user would usually be stored in the user partition 434.

The computing device 400 also comprises an electronic chip sensor 456. The electronic chip sensor 456, together with a suitable application, may be used to detect an electronic chip that is present in conventional credit or debit cards. The electronic chip sensor 456 may have contact pads for reading electronic chips of contact configuration (e.g. those provided on an exposed surface of a payment card) or a wireless transceiver for reading electronic chips of contactless configuration (e.g. those provided within or embedded inside a payment card).

The POS terminal 102 is configured to permit a transaction indicating an amount that is less than a threshold amount. The electronic chip sensor 456, the at least one processor (e.g. application processor 418) and the at least one memory (e.g. RAM 426, long-term storage 428) with its computer program code are configured to cause the POS terminal 102 at least to receive transaction data relating to a transaction, the transaction data indicating an amount. The at least one memory and the computer program code are further configured to, with the at least one processor, determine if the amount is less than the threshold amount, the threshold amount referring to an amount the POS terminal 102 is authorised to permit.

The at least one memory and the computer program code are further configured to, with the at least one processor, cause the POS terminal 102 to permit the transaction to proceed in response to the determination if the amount is less than the threshold amount.

The POS terminal 102 of FIG. 4 may execute the method shown in FIG. 2 when used to permit a transaction indicating an amount that is less than a threshold amount. This method comprises, at step 202, receiving transaction data relating to a transaction, the transaction data indicating an amount. The method further comprises, at step 204, determining if the amount is less than the threshold amount, the threshold amount referring to an amount that the POS is authorised to permit. The method further comprises, at step 206, permitting the transaction to proceed in response to the determination if the amount is less than the threshold amount.

The POS terminal 102 executes instructions which may be stored in any one or more of the RAM 426 or the long-term storage 428. These components 426 and 428 provide a non-transitory computer readable medium having stored thereon executable instructions for controlling the POS terminal 102 to perform steps comprising: a) receiving transaction data relating to a transaction, the transaction data indicating an amount; b) determining if the amount is less than a threshold amount, the threshold amount referring to an amount the POS is authorised to permit; and c) permitting the transaction to proceed in response to the determination if the amount is less than the threshold amount. Further, the POS terminal 102 may store received transaction data relating to transactions that the POS terminal 102 has permitted to proceed in the any one or more of the RAM 426, the long-term storage 428 or an external-based memory. The external-based memory may be connected to the POS terminal 102 via a wired data communication port 458 or wirelessly connected via the antenna 410.

In an implementation, the payment network server 104 may be generally described as a physical device comprising at least one processor 502 and at least one memory 504 including computer program code. An example of the payment network server 104 is shown in FIG. 5. In this example, the payment network server 104 is described with reference to FIG. 1, where the payment network server 104 is in communication with the acquirer server 105, the issuer server 106 and the database 108.

In FIG. 5, the payment network server 104 includes a processor 502, the internal memory 114 and a communication module 510. Data may be transferred between the processor 502 and internal memory 114 through a data connection such as, for example, a data bus. Likewise, data may be transferred between the processor 502 and the communication module 510 through a data connection such as, for example, a data bus. The processor further includes a determining module 506 and an identifying module 508. In an embodiment, the determining module 506 and identifying module 508 may be separate from the processor 502, such that communication and data transfer between the processor 502, determining module 506 and identifying module 508 may be through data bus connection between the modules. The communication module 510 further includes a receiving module 512 and a transmitting module 514.

The receiving module 512 receives data such as transaction data relating to a plurality of transactions that are permitted to proceed and an identifier relating to the transaction data from the acquirer server 105. Such data may be received via a wired or wireless internet connection. The received data is sent, for example via a data bus connection between the receiving module 512 and the processor 502, from the receiving module 512 to the processor 502. The determining module 506 of the processor 502 determines if the received identifier matches with an identifier in a register of identifiers each identifying a corresponding POS terminal, where the register of identifiers may be stored in the database 108 or the internal memory 114. If the register of identifiers is stored in the database 108, the communication module 506 facilitates the comparison performed by the processor 502 by receiving (via the receiving module 512) and transmitting (via the transmitting module 514) data between the processor 502 and the database 108, where data may be transferred between the communication module 510 and the database 108 via a wired or wireless data connection. When it is determined by the determining module 506 that the received identifier matches an identifier in the register, the identifying module 508 identifies a corresponding transaction data relating to each of the plurality of transactions. The identifying module 508 also identifies a respective issuer indicated in each identified transaction data and forwards, via the transmitting module 514, each identified transaction data to an issuer server 106 associated with the respective identified issuer. The internal memory 114 includes computer program code that, when executed by the processor 502, causes the payment network server 104 to perform the operations as mentioned above.

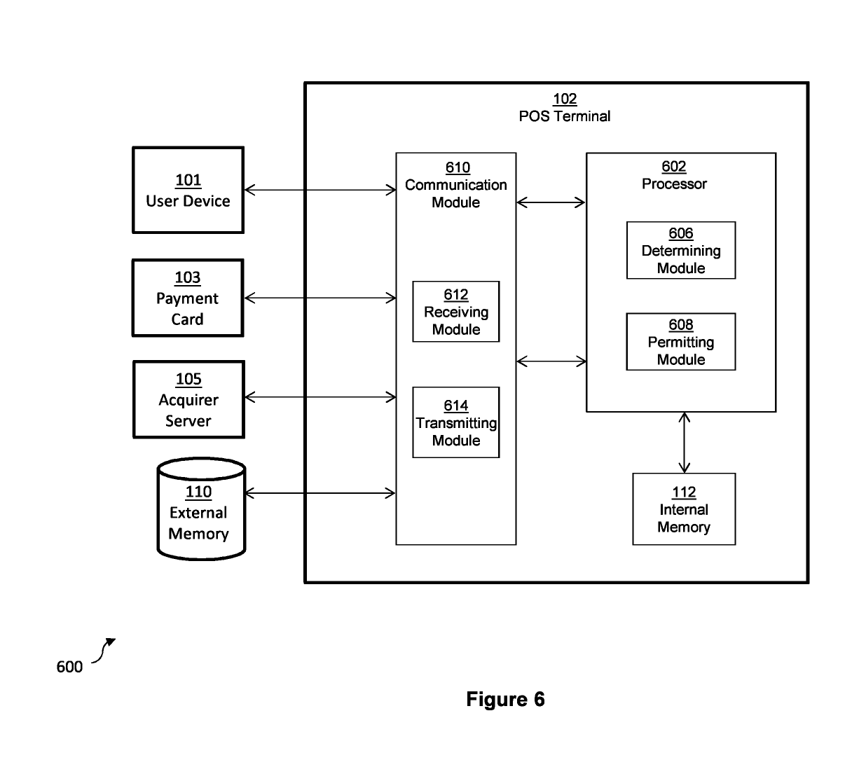

In an implementation, the POS terminal 102 may be generally described as a physical device comprising at least one processor 602 and at least one memory 604 including computer program code. An example of the POS terminal 102 is shown in FIG. 6. In this example, the POS terminal 102 is described with reference to FIG. 1, where the POS terminal 102 is in communication with the user device 101, payment card 103, acquirer server 105 and the external memory 110.

In FIG. 6, the POS terminal 102 includes a processor 602, the internal memory 112 and a communication module 610. Data may be transferred between the processor 602 and internal memory 112 through a data connection such as, for example, a data bus. Likewise, data may be transferred between the processor 602 and the communication module 610 through a data connection such as, for example, a data bus. The processor further includes a determining module 606 and a permitting module 608. In an embodiment, the determining module 606 and permitting module 608 may be separate from the processor 602, such that communication and data transfer between the processor 602, determining module 606 and identifying module 608 may be through data bus connection between the modules. The communication module 610 further includes a receiving module 612 and a transmitting module 614.

The receiving module 612 receives data such as transaction data relating to a transaction from the user device 101. Such data may be received via a wireless internet connection or NFC communication with the user device 101. If the transaction is initiated by the payment card 103, the data may be received by reading data from a chip or magnetic strip of the payment card 103 (if the transaction is initiated by swiping payment card 103 at the POS terminal 102) or via NFC communication with the payment card 103. The received data is sent, for example via a data bus connection between the receiving module 612 and the processor 602, from the receiving module 612 to the processor 602. The determining module 606 of the processor 602 determines if the amount indicated in the transaction data is less than the threshold amount, the threshold amount referring to an amount that the POS terminal is authorised to permit. The threshold amount may be stored in the internal memory 112 or external memory 110. If the threshold amount is stored in the external memory 110, the communication module 610 facilitates the determining step performed by the determining module 606 by receiving (via the receiving module 612) and transmitting (via the transmitting module 614) data between the processor 602 and the external memory 110, where data may be transferred between the communication module 610 and the external memory 110 via a wired or wireless data connection. When it is determined by the determining module 606 that the amount is less than the threshold amount, the permitting module 608 permits the transaction to proceed. The processor 602 may store the transaction data relating to the permitted transaction in the internal memory 112, or the external memory 110 where the transaction data is transmitted by the transmitting module 614 to the external memory 110. The determining module 606 also determines if a total amount is equal to or more than the threshold amount, the total amount relating to a sum of amounts indicated in one or more transactions that have been permitted and the amount indicated in the transaction data. The transaction data relating to the one or more transactions that have been permitted may be stored in the internal memory 112 or the external memory 110. When it is determined that the total amount is equal to or more than the threshold amount, the transmitting module 614 forwards transaction data relating to the one or more transactions that have been permitted and the received transaction data to the payment network server 104 via the acquirer server 105, wherein the transaction data relating to the one or more transactions that have been permitted is received subsequent to a forwarding of transaction data. The forwarding of transaction data may be via a wireless or wired internet connection. The processor 602 may include an identifier of the POS terminal 102 into the transaction data of the one or more transactions that have been permitted and the received transaction data for forwarding to the payment network server 104, the identifier identifying the POS terminal 102. The internal memory 112 also includes computer program code that, when executed by the processor 602, causes the POS terminal 102 to perform the operations as mentioned above.

Some portions of the description herein are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “requesting, “permitting”, “adding”, “setting”, “forwarding”, “changing”, “performing”, “storing”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description herein.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

It will be appreciated by a person skilled in the art that numerous variations and/or modifications may be made to the present invention as shown in the specific embodiments without departing from the scope of the appended claims as broadly described. The present embodiments are, therefore, to be considered in all respects to be illustrative and not restrictive.

1. A POS terminal for permitting a transaction indicating an amount that is less than a threshold amount, the POS terminal comprising:
at least one processor; and
at least one memory including computer program code;
the at least one memory and the computer program code configured to, with the at least one processor, cause the POS terminal at least to:
receive transaction data relating to the transaction, the transaction data indicating the amount;
determine if the amount indicated in the transaction data is less than the threshold amount, the threshold amount referring to an amount that the POS terminal is authorised to permit; and
permit the transaction to proceed in response to the determination if the amount is less than the threshold amount.

2. The POS terminal of claim 1, wherein the at least one memory and the computer program code are further configured to, with the at least one processor, cause the POS terminal to:
permit the transaction to proceed in response to the determination if the amount is less than the threshold amount, wherein the POS terminal is not in internet communication with a payment network server.

3. The POS terminal of claim 2, wherein the at least one memory and the computer program code are further configured to, with the at least one processor, cause the POS terminal to:
determine if a total amount is equal to or more than the threshold amount, the total amount relating to a sum of amounts indicated in one or more transactions that have been permitted and the amount indicated in the transaction data; and
forward transaction data relating to the one or more transactions that have been permitted and the received transaction data to the payment network server in response to the determination if the total amount is equal to or more than the threshold amount, wherein the transaction data relating to the one or more transactions that have been permitted is received subsequent to a forwarding of transaction data.

4. The POS terminal of claim 3, wherein the at least one memory and the computer program code are further configured to, with the at least one processor, cause the POS terminal to forward the transaction data relating to the one or more transactions that have been permitted and the received transaction data to the payment network server in response to the determination if the total amount is equal to or more than the threshold amount.

5. The POS terminal of claim 3, wherein the at least one memory and the computer program code are further configured to, with the at least one processor, cause the POS terminal to include an identifier of the POS terminal into the transaction data of the one or more transactions that have been permitted and the received transaction data for forwarding to the payment network server, the identifier identifying the POS terminal.

6. The POS terminal of claim 1, wherein the at least one memory and the computer program code are further configured to, with the at least one processor, cause the POS terminal to receive the transaction data from a user device, wherein the POS terminal is not in internet communication with the user device.

7. The POS terminal of claim 1, wherein the at least one memory and the computer program code are further configured to, with the at least one processor, cause the POS terminal to determine if a payment account indicated in the transaction data is one that is subscribed to a service for permitting a transaction indicating an amount that is less than the threshold amount.

8. A payment network server comprising:
at least one processor; and
at least one memory including computer program code;
the at least one memory and the computer program code configured to, with the at least one processor, cause the payment network server at least to:
receive transaction data relating to a plurality of transactions;
receive an identifier relating to the transaction data;
determine if the received identifier matches an identifier in a register of identifiers each identifying a corresponding POS terminal; and
identify a corresponding transaction data relating to each of the plurality of transactions when it is determined that the received identifier matches an identifier in the register.

9. The payment network server of claim 8, wherein the at least one memory and the computer program code are further configured to, with the at least one processor, cause the payment network server to:
determine, from the identified transaction data, a respective issuer facilitating each of the plurality of transactions; and
forward the identified transaction data for each of the plurality of transactions to the respective determined issuer.

10. The payment network server of claim 8, wherein the at least one memory and the computer program code are further configured to, with the at least one processor, cause the payment network server to set a threshold amount for a POS terminal that is configured for permitting a transaction indicating an amount that is less than the threshold amount, the threshold amount referring to an amount that the POS terminal is authorised to permit.

11. The payment network server of claim 10, wherein the at least one memory and the computer program code are further configured to, with the at least one processor, cause the payment network server to set the threshold amount based on transaction history of the POS terminal.

12. A method for permitting a transaction indicating an amount that is less than a threshold amount, the method comprising:
receiving transaction data relating to the transaction, the transaction data indicating the amount;
determining if the amount indicated in the transaction data is less than the threshold amount;
permitting the transaction to proceed in response to the determination if the amount is less than the threshold amount;
storing the transaction data in a memory when the transaction is permitted to proceed;
determining if a total amount is equal to or more than the threshold amount, the total amount relating to a sum of amounts indicated in one or more transactions that have been permitted and the amount indicated in the transaction data; and
forwarding transaction data relating to the one or more transactions that have been permitted and the received transaction data to a payment network server when the total amount is equal to or more than the threshold amount, wherein the transaction data relating to the one or more transactions that have been permitted is received subsequent to a forwarding of transaction data.

13. The method of claim 12, wherein the permitting is done by a POS terminal, wherein the POS terminal is not in internet communication with the payment network server.

14. The method of claim 12, further comprising including, by a POS terminal, an identifier into the transaction data of the one or more transactions that have been permitted and the received transaction data for forwarding to the payment network server, the identifier identifying the POS terminal.

15. The method of claim 12, further comprising receiving, at a POS terminal, the transaction data from a user device, the POS terminal not being in internet communication with the user device.

16. The method of claim 12, further comprising determining if a payment account indicated in the transaction data is one that is subscribed to a service for permitting transactions indicating an amount that is less than the threshold amount.

17. The method of claim 12, further comprising setting the threshold amount based on transaction history of a POS terminal.

18. The method of claim 17, wherein the threshold amount is set by to the POS terminal by the payment network server.

19. The method of claim 12, further comprising:
receiving, by the payment network server, the transaction data relating to the one or more transactions;
receiving, by the payment network server, an identifier relating to the transaction data;
determining, by the payment network server, if the received identifier matches an identifier in a register of identifiers each identifying a corresponding POS terminal; and
identifying, by the payment network server, a corresponding transaction data relating to each of the plurality of transactions when it is determined that the received identifier matches an identifier in the register.

20. The method of claim 19, further comprising:
determining, by the payment network server, from the identified transaction data, a respective issuer facilitating each of the plurality of transactions; and
forwarding, by the payment network server, the identified transaction data for each of the plurality of transactions to the respective determined issuer.
